(19) United States
(12) Patent Application Publication
(10) Pub. No.: US 2011/0302743 A1
(43) Pub. Date: Dec. 15, 2011

(54) HINGE APPARATUS FOR A DOOR

(76) Inventors: Hyeon-Jung Kim, Gyeongsangnam-do (KR); Jae-Sung Park, Gyeongsangnam-do (KR); Hyeon-Deok Seo, Gyeongsangnam-do (KR); Young-Su Lee, Gyeongsangnam-do (KR)

(21) Appl. No.: 13/148,452

(22) PCT Filed: Nov. 25, 2009
(86) PCT No.: PCT/KR2009/006964

§ 371 Date: Aug. 8, 2011

(30) Foreign Application Priority Data
Nov. 25, 2009 (KR) 10-2009-0114246

(51) Int. Cl. E05F 1/12; E05D 7/04; E05D 5/10

(52) U.S. Cl. 16/248; 16/386; 16/303

(57) ABSTRACT

The present invention relates to a hinge device for doors which are used in products, such as refrigerators, etc., to open and close them. In the hinge device, an upper operation unit is connected to a lower operation unit in such a way that a lower cam provided in the lower operation unit is interlocked with an upper cam provided in the upper operation unit by a single shaft, and that the lower cam and the upper cam are moved upwards and downwards in opposite directions.

### TECHNICAL FIELD

The present invention relates to a hinge device for doors which are used in products, such as refrigerators, etc., to open and close them.

### BACKGROUND ART

Generally hinges are used in doors or the like which open and close products. In each product, a hinge suitable for the characteristics of the product is selected and used. Particularly, hinges for doors of products, such as refrigerators, must not only open and close smoothly but also have a damping function that prevents shock from being applied to a product by a door being closed with excessive force.

To date many techniques pertaining to hinges for doors have been proposed, a representative example of which was proposed in Korean Patent Application No. 10-2003-0026054 which was entitled “Hinge assembly”.

FIG. 1 is an exploded perspective view of the hinge assembly. As shown in the drawing, the hinge assembly includes a housing 10 which is fastened to a main body of a product, and a rotary cam 20 which is integrally coupled to a cover or door D and installed in the housing 10 so that the rotary cam 20 rotates along with the rotation of the cover or door D. The hinge assembly further includes a sliding cam 30 which is operated in conjunction with the rotary cam 20 so as to reciprocate in the longitudinal direction, and a main torque spring 2 which is compressed or restored by the reciprocating movement of the sliding cam 30 to apply a predetermined amount of rotational torque to the cover or door. The hinge assembly further includes a damping spring 4 which damps the door or cover at a predetermined position in opposition to the main torque spring 2, and a rotational rod 40 which interlocks with the rotary cam 20 in such a way that the rotational rod 40 rotates along with the rotary cam 20 on at least one portion of the entire rotation section of the rotary cam 20. The hinge assembly further includes a friction member 5 which is interlocked with at least one surface of the rotational rod 40 to apply frictional resistance to the rotational rod 40 that rotates in the housing 10.

In addition to this, many related techniques have been proposed, but these techniques which have been hitherto known have only a basic opening and closing function and a damping function using a pair of cams and springs. In such a conventional structure, the damping function is not satisfactory. Moreover, the conventional structure cannot satisfy special functions which are required depending on the angle at which a door is open and closed.

For instance, in the case of the door of a refrigerator, when the door opens within an angular range from the maximum angle to a predetermined angle, the door maintains the open state. When the angle at which the door opens is not in the angular range, the door automatically closes. Furthermore, in a section in which the door is automatically closed, there is a damping section to prevent the door from being closed with excessive force. However, if the damping function is continuously applied to the door until the door is completely closed, the door may not completely close, or the sealing force of the door may be reduced. In other words, just before the door has completely closed, the damping function needs to be removed so that the door is more reliably closed.

### DISCLOSURE

### Technical Problem

Accordingly, the present invention has been made keeping in mind the above problems occurring in the prior art, and an object of the present invention is to provide a hinge device for doors which can not only enhance a damping function but also remove the damping function when necessary just before a door is closed.

### Technical Solution

In order to accomplish the above object, the present invention provides a hinge device for a door, including: an upper operation unit having an upper cam; and a lower operation unit connected to the upper operation unit. The lower operation unit has a lower cam connected to the upper cam by a main shaft in such a way that the upper cam and the lower cam move upwards and downwards in directions opposite to each other.

The upper operation unit may be connected to the lower operation unit by a connection block. The connection block may have at a central portion thereof a shaft hole through which an upper end of the main shaft passes.

The upper operation unit may include: an upper housing having a receiving hole extending a predetermined length from a lower end of the upper housing, and a plurality of guide grooves formed in a circumferential inner surface of the receiving hole in a longitudinal direction of the upper housing, with an adjustment bolt tightened into an upper end of the upper housing, the adjustment bolt extending into the receiving hole; an auxiliary shaft disposed on an upper surface of the connection block and installed in the upper housing, the auxiliary shaft being coupled to the upper end of the main shaft so that rotational force of the main shaft is transmitted to the auxiliary shaft, with a first O-ring fitted over a head of the auxiliary shaft; a first rotary cam connected to and rotated by the auxiliary shaft; a first movable cam interlocked with the first rotary cam so that the first movable cam moves upwards or downwards along the guide grooves, with a second O-ring fitted over a circumferential outer surface of an upper end of the first movable cam, and a flow hole formed through a central portion of the first movable cam in a longitudinal direction thereof; an upper spring supported by an upper surface of the first movable cam and a stopper provided in the receiving hole; and a flow rate control pin inserted into the flow hole, the flow rate control pin having a circumferential outer surface having a tapered shape, and an upper end connected to the adjustment bolt so that a position of the flow rate control pin is adjustable, whereby a flow rate of fluid is adjusted depending on a distance between the flow rate control pin and an inner surface of the flow hole.

Furthermore, a first center cam and a second center cam may be provided in at least one pair between the first rotary cam and the first movable cam, wherein the first center cam linearly moves, and the second center cam is rotatable and linearly movable.

The flow rate control pin may have: a center hole formed along a longitudinal axis of the flow rate control pin, the center hole extending a predetermined length from a lower end of the flow rate control pin; an enlarged-diameter hole extending from an upper end of the center hole, the enlarged-diameter hole having an inner diameter greater than an inner diameter of the center hole, with a ball inserted in the enlarged-diameter hole; and at least one discharge hole formed through a circumferential outer surface of the flow rate control pin, the discharge hole communicating with the enlarged-diameter hole.

The flow rate control pin may further have a damping removal depression formed in the circumferential outer surface of the flow rate control pin at a position corresponding to the center hole in such a way that an outer diameter of the damping removal depression is less than an outer diameter of the flow rate control pin.

In addition, guide protrusions may be provided on a circumferential outer surface of the first movable cam and a circumferential outer surface of the first center cam. The guide protrusions may be inserted into the corresponding guide grooves.

The fluid for damping may be provided in the upper housing, and intensity of a damping force produced thereby may be adjusted by varying the distance between the flow rate control pin and the inner surface of the flow hole of the first movable cam.

Furthermore, when the door is converted from an open state into a closed state, in response to a rotation angle of the door, a damping function may be conducted and then removed by the damping removal depression so that the door is completely closed.

The lower operation unit may include: a lower housing having a hollow space therein; the main shaft installed in the lower housing, the main shaft having a lower end protruding downwards from a lower end of the lower housing; a second rotary cam fitted over the main shaft, the second rotary cam being rotated along with the main shaft; a second movable cam interlocked with the second rotary cam so that the second movable cam linearly moves in the longitudinal direction; and a lower spring provided on an upper surface of the second movable cam.

### Advantageous Effects

In a hinge device for doors according to the present invention, an upper operation unit is connected to a lower operation unit such that they are spatially separated from each other, wherein the upper operation unit has a damping function, and the lower operation unit has a basic opening and closing function. Thus, the degree of freedom in the design of the upper operation unit is improved so that the damping function is further enhanced.

Moreover, when necessary, the upper operation unit can temporarily remove the damping function in such a way that just before the door has completely closed, the damping function can be removed. Thereby, the door can reliably be completely closed.

### DESCRIPTION OF DRAWINGS

FIG. 1 is an exploded perspective view of a hinge assembly, according to a conventional technique;

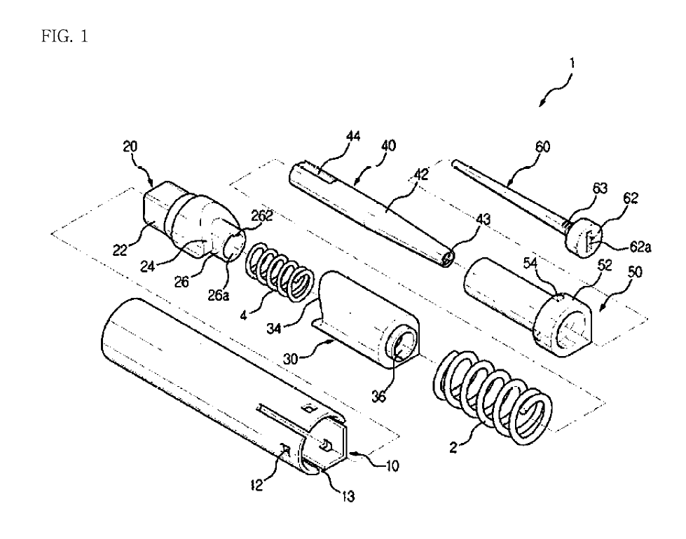

FIG. 2 is an exploded perspective view of a hinge device for a door, according to a first embodiment of the present invention;

FIG. 3 is a sectional view illustrating the assembled hinge device;

FIG. 4 is an exploded sectional view illustrating the hinge device;

FIG. 5 is a perspective view illustrating a flow rate control pin of the hinge device;

FIG. 6 is a perspective view illustrating a first rotary cam and a first movable cam of the hinge device;

FIG. 7 is an exploded perspective view of a hinge device for a door, according to a second embodiment of the present invention;

FIG. 8 is a sectional view illustrating the assembled hinge device;

FIG. 9 is an exploded sectional view illustrating the hinge device;

FIG. 10 is a perspective view illustrating the installation of a first rotary cam and a second drive cam of the hinge device; and

FIG. 11 is a view showing movement of an upper cam and a lower cam depending on opening or closing the door.

### DESCRIPTION OF THE ELEMENTS IN THE DRAWINGS

100: lower operation unit 110: lower cam
110a: second rotary cam 110b: second movable cam
120: lower housing 121: guide groove
122: stop support 130: lower spring
200: upper operation unit 210: upper cam
210a: first rotary cam 210b: first movable cam
210c: first center cam 210d: second center cam
220: upper housing 221: receiving hole
222: guide groove 223: stopper
230: auxiliary shaft 231: head
240: upper spring 250: flow rate control pin
251: center hole 252: enlarged-diameter hole
253: ball 254: discharge hole
255: damping removal depression 260: adjustment bolt
300: connection block 310: shaft hole
p: guide protrusion S: shaft
S1: support protrusion R: O-ring
B: bolt

### BEST MODE

A hinge device for doors according to the present invention will be described in detail with reference to the drawings that are attached to provide a better understanding of the present invention. Although the attached drawings illustrate only embodiments that can be derived from the present invention, modifications of the embodiments, such as simple structural changes or additions, substitutions for equivalents, etc., must also be regarded as falling within the bounds of the present invention.

The hinge device for doors may be used in a door of a refrigerator or in other doors or covers for opening and closing a variety of electric appliances or electronics.

The hinge device largely includes a lower operation unit 100 and an upper operation unit 200. The lower operation unit 100 is connected to the upper operation unit 200 by a connection block 300. The lower operation unit 100 includes a lower cam 110, and the upper operation unit 200 includes an upper cam 210. These elements are connected to each other by a main shaft S. The lower cam 110 and the upper cam 210 move in opposite directions, wherein when the lower cam 110 moves upwards, the upper cam 210 moves downwards, and in contrast, when the lower cam 110 moves downwards, the upper cam 210 moves upwards.

For example, when the door which has been closed is open, the lower cam 110 engages in upward motion, and the upper cam 210 engages in downward motion. At such a time, a lower elastic member (a lower spring) which is installed in the lower operation unit 100 is compressed to store energy so that the door can be automatically closed when it is closed. When the door which has been open is closed, the lower cam 110 is moved downwards and the door automatically closes as the elastic member which has been compressed is loosened. Simultaneously, the upper cam 210 moves upwards to provide a damping function. The damping function of the upper operation unit 200 provided with the upper cam 210 is accomplished by a combination of the characteristic structure of the cam, the elastic force of a spring, and fluid contained in the upper operation unit 200.

Although it will be mentioned later herein, the upper cam of the upper operation unit includes a combination of a first rotary cam and a first movable cam, and the lower cam of the lower operation unit includes a combination of a second rotary cam and a second movable cam. Furthermore, the upper cam may further include a first center cam and a second center cam which are located between the first rotary cam and the first movable cam.

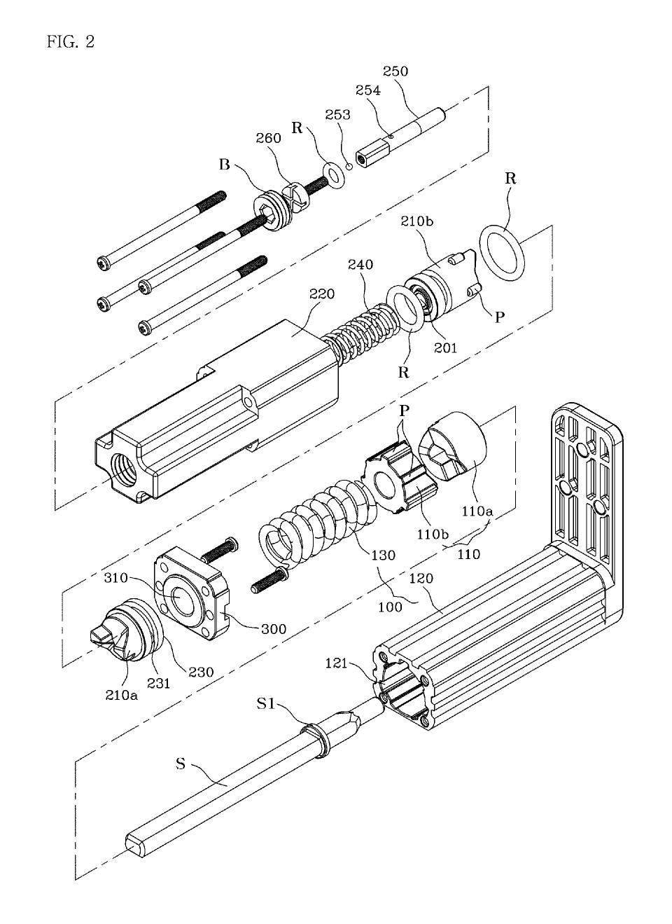

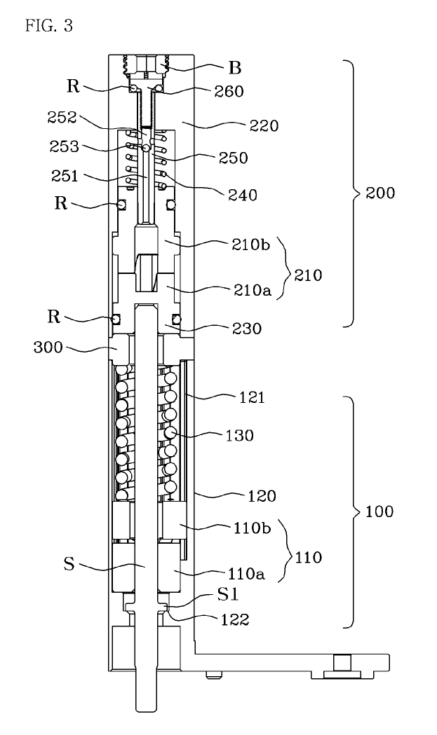

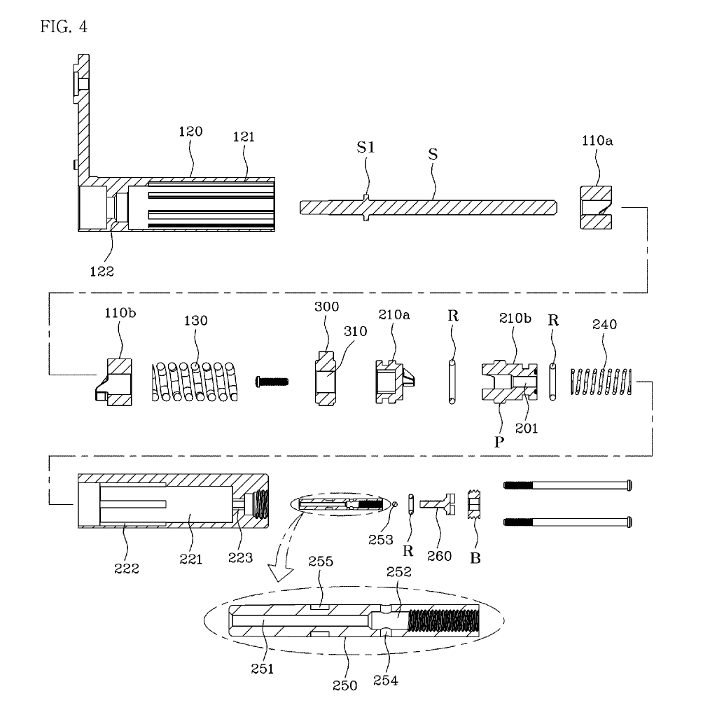

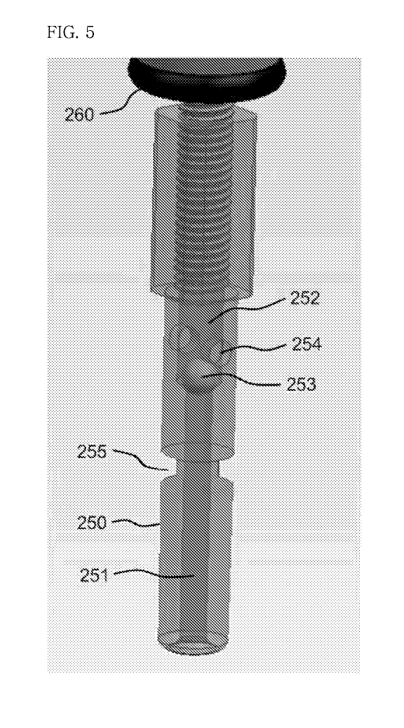

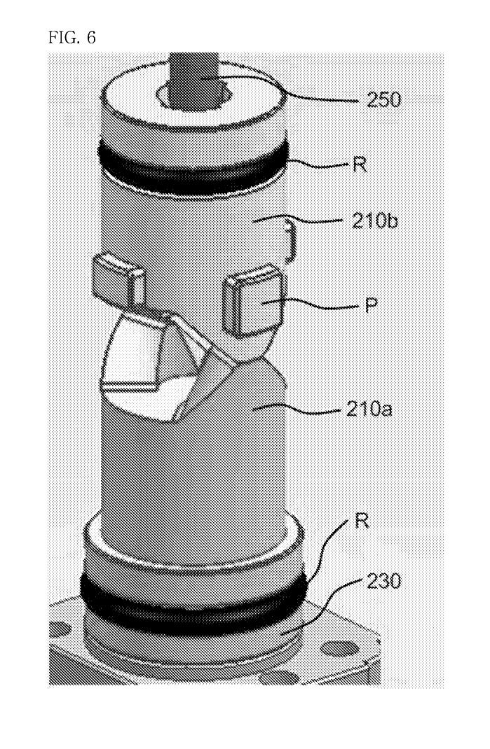

Hereinafter, a hinge device for a door according to a first embodiment which is derived from the technical spirit of the present invention will be described. FIG. 2 is an exploded perspective view of the hinge device according to the first embodiment of the present invention. FIG. 3 is a sectional view illustrating the assembled hinge device. FIG. 4 is an exploded sectional view illustrating the hinge device. FIG. 5 is a perspective view illustrating a flow rate control pin of the hinge device. FIG. 6 is a perspective view illustrating a first rotary cam and a first movable cam of the hinge device.

As shown in the drawings, the hinge device of the first embodiment includes a lower operation unit 100 and an upper operation unit 200 which are connected to each other by a connection block 300. The lower operation unit 100 includes a lower housing 120, a main shaft S, a second rotary cam 110a, a second movable cam 110b and a lower spring 130. The shape of the lower housing 120 may change according to the kind of the door or the intended use of the hinge device. The lower housing 120 has a hollow space therein. A plurality of guide grooves 121 is formed in a circumferential inner surface of the lower housing 120.

The main shaft S is inserted into the lower housing 120 in such a way that a lower end of the main shaft S protrudes downwards from a lower end of the lower housing 120. Here a stop support 122 is provided on the inner surface of the lower housing 120 at a position adjacent to the lower end thereof, and a stop protrusion S1 is provided on a predetermined portion of the main shaft S so that the stop protrusion S1 is stopped by the stop support 122. An upper end of the longish main shaft S extends into an upper housing 220 of the upper operation unit 200 via a shaft hole 310 which is formed through the connection block 300.

The second rotary cam 110a and the second movable cam 110b are provided in a pair on the main shaft s that is installed in the lower operation unit 100. The second rotary cam 110a is firmly fitted over the main shaft S so that it rotates along with the main shaft S. The second movable cam 110b is in contact with the second rotary cam 110a so that when the main shaft S rotates in one direction, the second movable cam 110b is linearly moved and pushed upwards by the secondary rotary cam 110a along a path defined by the shape of the junction between the second rotary cam 110a and the second movable cam 110b. To make the vertical linear movement of the second movable cam 110b possible, guide protrusions P are provided on a circumferential outer surface of the second movable cam 110b and are movably inserted into the respective guide grooves 121 formed in the circumferential inner surface of the lower housing 120.

Meanwhile, the lower spring 130 is provided on an upper surface of the second movable cam 110b. An upper end of the lower spring 130 is brought into contact with the connection block 300 and is supported by it. The connection block 300 is fastened to an upper end of the lower housing 120. The upper housing 220 of the upper operation unit 200 which will be described later herein is fastened to the connection block 300.

The lower housing 120 is coupled to the door. The lower end of the main shaft S is rotatably coupled to a main body of a product provided with the door. Thus, when the door opens or is closed, the main shaft S rotates. Thereby, the second rotary cam 110a also rotates so that the second movable cam 110b linearly moves upwards or downwards.

Next the upper operation unit 200 coupled to an upper surface of the connection block 300 will be described. The upper operation unit 200 includes an upper housing 220, an auxiliary shaft 230, a first rotary cam 210a, a first movable cam 210b, an upper spring 240 and a flow rate control pin 250.

The upper housing 220 has a receiving hole 221 which extends from a lower end of the upper housing 220 so that a hollow space is created. Guide grooves 222 are formed in the receiving hole 221 and extend in the longitudinal direction of the upper housing 220. An adjustment bolt 260 is inserted into an upper end of the upper housing 220 and reaches the receiving hole 221. The adjustment bolt 260 is thread-coupled to an upper end of the flow rate control pin 250 which will be described later herein. The position of the flow rate control pin 250 can be adjusted depending on the direction in which the adjustment bolt 260 rotates. Preferably, an O-ring R is interposed between the adjustment bolt 260 and the upper housing 220 to prevent fluid from leaking out of the receiving hole 221. Furthermore, the adjustment bolt 260 may be configured such that it can be directly rotated. Alternatively, a separate bolt B may be provided on the adjustment bolt 260, and the adjustment bolt 260 may be rotated by rotating the bolt B.

The auxiliary shaft 230 is coupled to an upper end of the main shaft S that is inserted into the lower housing 120 and that enters the interior of the upper housing 220 via the connection block 300. An O-ring R is fitted over a circumferential outer surface of a head 231 that is a lower end of the auxiliary shaft 230. The auxiliary shaft 230 is disposed on the upper surface of the connection block 300 so that the rotating force of the main shaft S is transmitted to the auxiliary shaft 230.

The first rotary cam 210a is coupled to the auxiliary shaft 230. The first rotary cam 210a rotates along with the auxiliary shaft 230. The first rotary cam 210a coupled to the auxiliary shaft 230 may be integrated with the auxiliary shaft 230. Alternatively, the first rotary cam 210a may be separately manufactured and then assembled with the auxiliary shaft 230. In this embodiment, the first rotary cam 210a is provided on the upper end of the auxiliary shaft 230 in such a way that the first rotary cam 210a is integrated with the auxiliary shaft 230.

The first movable cam 210b is provided in the upper housing 220 and is moved upwards and downwards in conjunction with the first rotary cam 210a. Guide protrusions P are provided on a circumferential outer surface of the first movable cam 210b so as to be movable upwards and downwards along the respective guide grooves 222 of the receiving hole 221. In addition, an O-ring R is fitted over the circumferential outer surface of an upper end of the first movable cam 210b. A flow hole 201 is longitudinally formed through a central portion of the first movable cam 210b. The first movable cam 210b is in contact with the first rotary cam 210a in such a way that when the first rotary cam 210a is rotated by the rotation of the main shaft S, the first movable cam 210b is moved upwards or downwards.

The upper spring 240 is provided on an upper surface of the first movable cam 210b. An upper end of the upper spring 240 is supported by a stopper 223 provided in the receiving hole 221. The upper spring 240 is compressed or restored by the upward or downward movement of the first movable cam 210b.

Fluid is injected into the upper operation unit 200 to provide a damping function. The damping function may be used or removed depending on the direction in which the fluid moves and the flow rate of the fluid. To realize this function, the flow rate control pin 250 is installed in the upper housing 220. An upper end of the flow rate control pin 250 is connected to the adjustment bolt 260, and a lower end thereof is inserted into the flow hole 201. The circumferential outer surface of the flow rate control pin 250 which is inserted into the flow hole 201 is configured to have an inclined surface in such a way that the diameter thereof increases from the lower end of the flow rate control pin 250 to the upper end thereof. Thus, depending on the upward or downward movement of the first movable cam 210b, a distance between the flow rate control pin 250 and the inner surface of the flow hole 201 varies so that the flow rate of the fluid can be adjusted.

More preferably, a center hole 251 is formed in the flow rate control pin 250 and extends a predetermined length from the lower end of the flow rate control pin 250 along the longitudinal axis thereof. An enlarged-diameter hole 252 extends from an upper end of the center hole 251 of the flow rate control pin 250. A ball 253 having a diameter capable of closing the center hole 251 is inserted in the enlarged-diameter hole 252. At least one discharge hole 254 which communicates with the enlarged-diameter hole 252 is formed through the circumferential outer surface of the flow rate control pin 250. The fluid which is charged into the upper housing 220 is prevented by the O-ring R provided on the first movable cam 210b from moving out of the upper housing 220 along the inner surface of the upper housing 220. The fluid only flows through the center hole 251 and the gap between the flow rate control pin 250 and the inner surface of the flow hole 201.

For example, when the door is closed, the first movable cam 210b moves upwards. As the first movable cam 210b moves upwards, the distance between the flow rate control pin 250 and the inner surface of the flow hole 201 is reduced, and the center hole 251 is closed by the ball 253. Thereby, the flow rate of fluid which moves downwards is reduced, thus impeding the first movable cam 210b from moving upwards. As a result, the damping function is exhibited. In contrast, when the door opens, the first movable cam 210b moves downwards. Thereby, the distance between the flow rate control pin 250 and the inner surface of the flow hole 201 is increased, and the ball 253 which has closed the center hole 251 opens it. Then, fluid which has been in the lower side rapidly moves upwards through the flow hole 201 and the center hole 251, thus allowing the door to easily be opened.

Basically when the door is closed, the damping function must be exhibited so that the door closes smoothly without an impact being applied thereto. However, if the damping function continues to be exhibited until the door has completely closed, it acts as a factor which impedes the door from being completely closed. Therefore, in the present invention, while the door is being closed normally, the damping function is exhibited, but just before the door has completely closed, the damping function is removed so that the door is easily completely closed.

For this, a damping removal depression 255 which is a reduced-diameter portion is more preferably formed in the tapered outer surface of the flow rate control pin 250. The damping removal depression 255 is disposed below the discharge hole 254 at a position corresponding to the center hole 251 adjacent to the upper end of the center hole 251. As the first movable cam 210b moves upwards, the distance between the flow rate control pin 250 and the inner surface of the flow hole 201 is reduced so that the damping function is exhibited, but the moment that the damping removal depression 255 enters the flow hole 201, fluid rapidly flows into the lower side of the upper operation unit 200, thus mitigating the damping function.

Meanwhile, the distance between the flow rate control pin 250 and the inner surface of the flow hole 201 can be adjusted by changing the position of the flow rate control pin 250 using the adjustment bolt 260. Thereby, an initial flow rate of fluid can be adjusted, thus adjusting the intensity of the damping.

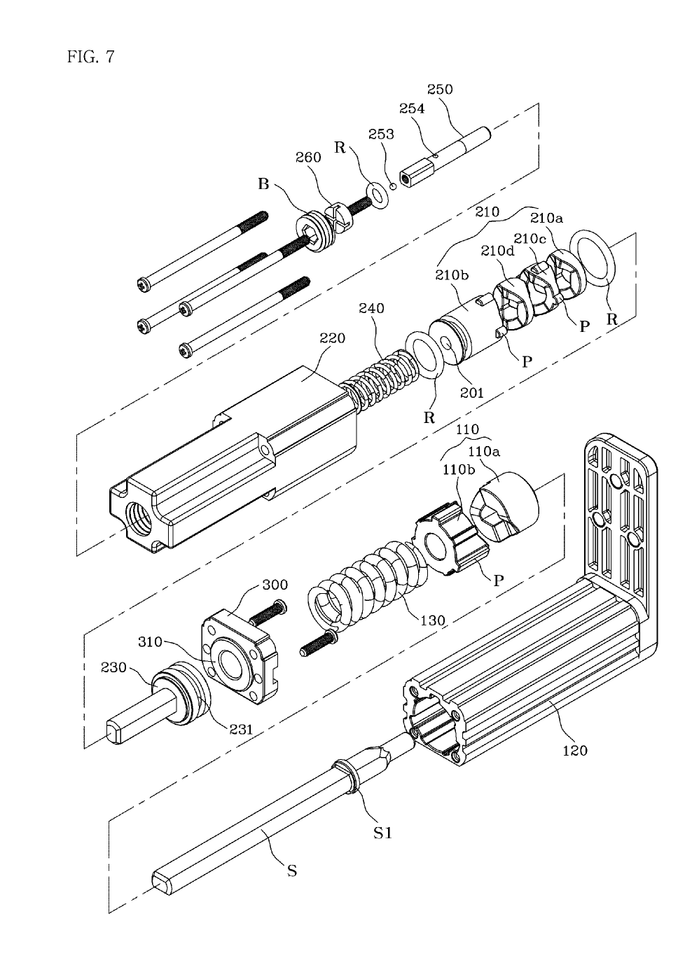

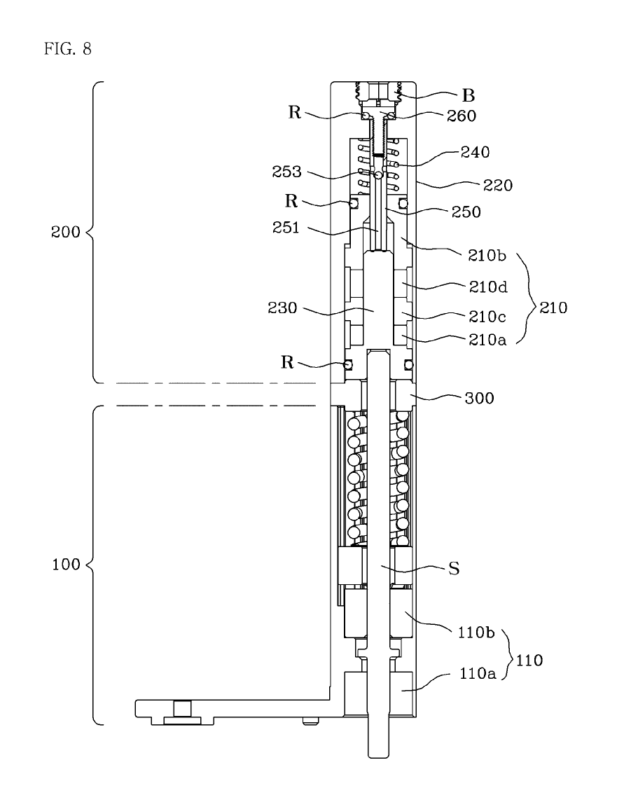

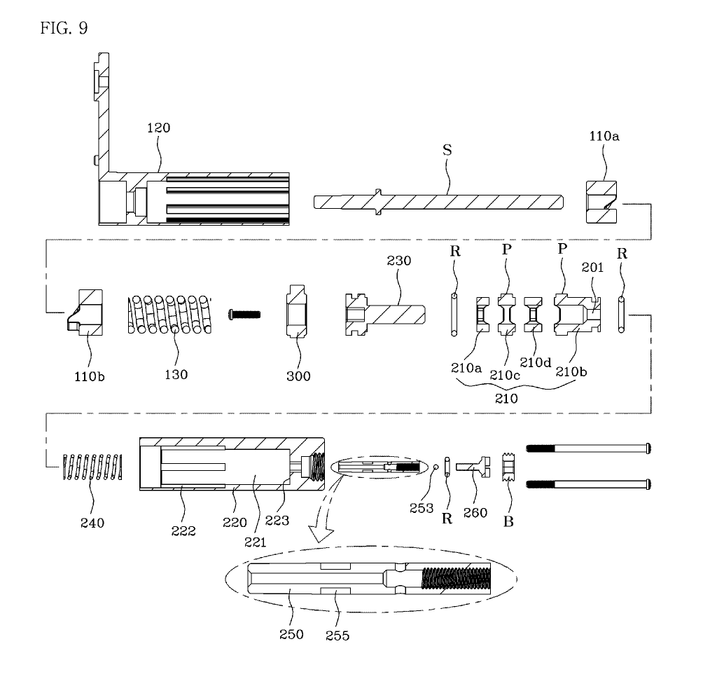

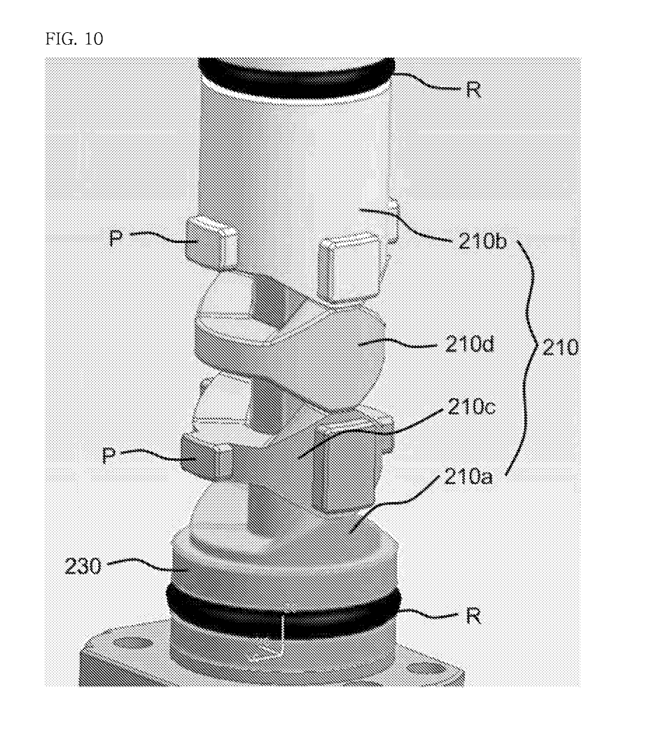

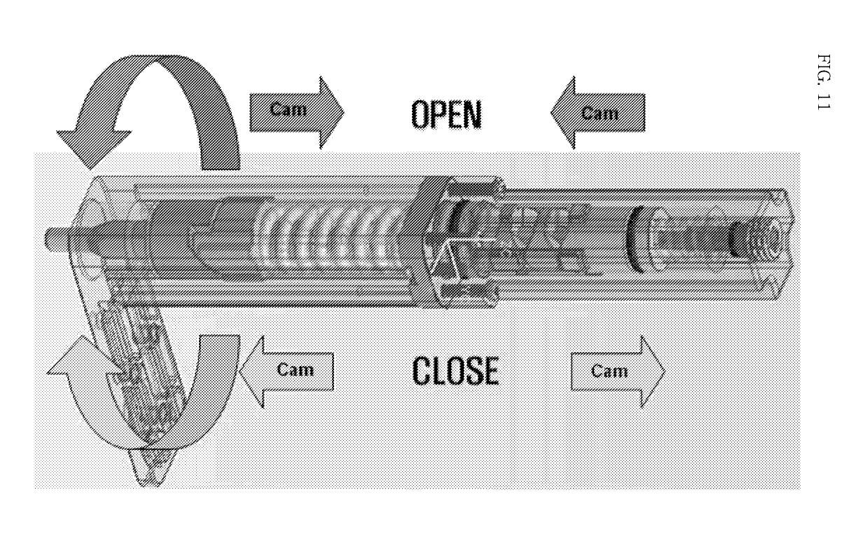

Next a second embodiment of the present invention will be explained. FIG. 7 is an exploded perspective view of a hinge device of the second embodiment. FIG. 8 is a sectional view illustrating the assembled hinge device. FIG. 9 is an exploded sectional view illustrating the hinge device. FIG. 10 is a perspective view illustrating the installation of a first rotary cam and a second drive cam of the hinge device. FIG. 11 is a view showing movement of an upper cam and a lower cam depending on whether the door is being opened or closed.

The general construction of the second embodiment is the same as that Of the first embodiment. Particularly, the second embodiment is characterized in that at least one pair of a first center cam 210c and a second center cam 210d are provided between a first rotary cam 210a and a first movable cam 210b.

The first center cam 210c linearly moves upwards and downwards. The second center cam 210d linearly moves and simultaneously rotates. Guide protrusions P are provided on a circumferential outer surface of the first center cam 210c and are inserted into the respective guide grooves 222 of the upper housing 220 so as to be linearly movable.

Although the second embodiment has the one pair of first center cam 210c and second center cam 210d, two or more pairs of first center cams 210c and second center cams 210d may be provided.

The operation of the second embodiment will be described in more detail. When the first rotary cam 210a rotates, the first center cam 210c linearly moves, and the second center cam 210d also rotates because it is coupled to the auxiliary shaft 230. Simultaneously, the second center cam 210d also linearly moves as the first center cam 210c linearly moves. In addition, the first movable cam 210b which is in contact with the second center cam 210d moves in the linear direction.

As such in the case where the at least one pair of first center cam 210c and second center cam 210d are provided between the first rotary cam 210a and the first movable cam 210b, the maximum stroke distance of the first movable cam 210b is markedly increased, thus enhancing the damping ability.

For example, if in the first embodiment the maximum stroke distance of the first movable cam 210b is 4.8 mm, the maximum stroke distance of the second embodiment having the first center cam 210c and the second center cam 210d becomes 8.4 mm.

The general principle of operation of the hinge device according to the present invention will be explained. When the door is opened or closed, the first movable cam 210b of the upper cam 210 of the upper operation unit 200 and the second movable cam 110b of the lower cam 110 of the lower operation unit 100 are moved in the opposite directions so that the lower operation unit 100 conducts the basic automatic closing function while the upper operation unit 200 exhibits the damping function.

When the door which has bee'n closed is opened, the second movable cam 110b moves upwards and thus compresses the lower spring 130 and, simultaneously, the first movable cam 210b moves downwards. At such times, the first movable cam 210b can be more easily moved downwards by the restoring force of the upper spring 240 which has been compressed and by the fluid which rapidly moves towards the upper side of the first movable cam 210b. Thereby, the door can be easily open.

On the other hand, when the door is closed, the second movable cam 110b moves downwards. At this time, the door can be automatically closed by the restoring force of the lower spring 130. Furthermore, the first movable cam 210b moves upwards, and as the door is closed, the damping force is increased so that the door closes slowly. Just before the door has completely closed, the damping force reduces due to the damp between the damping removal depression 255 and the flow hole 201 so that completely closing the door is smooth. Moreover, in the case where the first center cam 210c and the second center cam 210d are provided, the stroke distance of the first movable cam 210b is increased so that the damping function is further enhanced.

The hinge device for doors according to the present invention can be used not only in a refrigerator but also a variety of products having doors or covers which are opened and closed. The accompanying drawings are only preferred embodiments of the present invention.

### INDUSTRIAL APPLICABILITY

A hinge device for doors according to present invention can be used in a variety of products provided with doors or covers which are open and closed. Therefore, the present invention is a technique with high practical applicability.

1. A hinge device for a door, comprising:
an upper operation unit having an upper cam; and
a lower operation unit connected to the upper operation unit, the lower operation unit having a lower cam connected to the upper cam by a main shaft in such a way that the upper cam and the lower cam move upwards and downwards in directions opposite to each other.

2. The hinge device as set forth in claim 1, wherein the upper operation unit is connected to the lower operation unit by a connection block, the connection block having at a central portion thereof a shaft hole through which an upper end of the main shaft passes.

3. The hinge device as set forth in claim 2, wherein the upper operation unit comprises:
an upper housing having a receiving hole extending a predetermined length from a lower end of the upper housing, and a plurality of guide grooves formed in a circumferential inner surface of the receiving hole in a longitudinal direction of the upper housing, with an adjustment bolt tightened into an upper end of the upper housing, the adjustment bolt extending into the receiving hole;
an auxiliary shaft disposed on an upper surface of the connection block and installed in the upper housing, the auxiliary shaft being coupled to the upper end of the main shaft so that rotational force of the main shaft is transmitted to the auxiliary shaft, with a first O-ring fitted over a head of the auxiliary shaft;
a first rotary cam connected to and rotated by the auxiliary shaft;
a first movable cam interlocked with the first rotary cam so that the first movable cam moves upwards or downwards along the guide grooves, with a second O-ring fitted over a circumferential outer surface of an upper end of the first movable cam, and a flow hole formed through a central portion of the first movable cam in a longitudinal direction thereof;
an upper spring supported by an upper surface of the first movable cam and a stopper provided in the receiving hole; and
a flow rate control pin inserted into the flow hole, the flow rate control pin having a circumferential outer surface having a tapered shape, and an upper end connected to the adjustment bolt so that a position of the flow rate control pin is adjustable, whereby a flow rate of fluid is adjusted depending on a distance between the flow rate control pin and an inner surface of the flow hole.

4. The hinge device as set forth in claim 3, wherein a first center cam and a second center cam are provided in at least one pair between the first rotary cam and the first movable cam, wherein the first center cam linearly moves, and the second center cam is rotatable and linearly movable.

5. The hinge device as set forth in claim 3, wherein the flow rate control pin has: a center hole formed along a longitudinal axis of the flow rate control pin, the center hole extending a predetermined length from a lower end of the flow rate control pin; an enlarged-diameter hole extending from an upper end of the center, the enlarged-diameter hole having an inner diameter greater than an inner diameter of the center hole, with a ball inserted in the enlarged-diameter hole; and at least one discharge hole formed through a circumferential outer surface of the flow rate control pin, the discharge hole communicating with the enlarged-diameter hole.

6. The hinge device as set forth in claim 5, wherein the flow rate control pin further has a damping removal depression formed in the circumferential outer surface of the flow rate control pin at a position corresponding to the center hole in such a way that an outer diameter of the damping removal depression is less than an outer diameter of the flow rate control pin.

7. The hinge device as set forth in claim 4, wherein guide protrusions are provided on a circumferential outer surface of the first movable cam and a circumferential outer surface of the first center cam, the guide protrusions being inserted into the corresponding guide grooves.

8. The hinge device as set forth in claim 3, wherein the fluid for damping is provided in the upper housing, and intensity of a damping force produced thereby is adjusted by varying the distance between the flow rate control pin and the inner surface of the flow hole of the first movable cam.

9. The hinge device as set forth in claim 6, wherein when the door is converted from an open state into a closed state, in response to a rotation angle of the door, a damping function is conducted and then removed by the damping removal depression so that the door is completely closed.

10. The hinge device as set forth in claim 1, wherein the lower operation unit comprises:
a lower housing having a hollow space therein;
the main shaft installed in the lower housing, the main shaft having a lower end protruding downwards from a lower end of the lower housing;
a second rotary cam fitted over the main shaft, the second rotary cam being rotated along with the main shaft;
a second movable cam interlocked with the second rotary cam so that the second movable cam linearly moves in the longitudinal direction; and
a lower spring provided on an upper surface of the second movable cam.

11. The hinge device as set forth in claim 4, wherein the fluid for damping is provided in the upper housing, and intensity of a damping force produced thereby is adjusted by varying the distance between the flow rate control pin and the inner surface of the flow hole of the first movable cam.

12. The hinge device as set forth in claim 5, wherein the fluid for damping is provided in the upper housing, and intensity of a damping force produced thereby is adjusted by varying the distance between the flow rate control pin and the inner surface of the flow hole of the first movable cam.

13. The hinge device as set forth in claim 6, wherein the fluid for damping is provided in the upper housing, and intensity of a damping force produced thereby is adjusted by varying the distance between the flow rate control pin and the inner surface of the flow hole of the first movable cam.

14. The hinge device as set forth in claim 7, wherein the fluid for damping is provided in the upper housing, and intensity of a damping force produced thereby is adjusted by varying the distance between the flow rate control pin and the inner surface of the flow hole of the first movable cam.

15. The hinge device as set forth in claim 2, wherein the lower operation unit comprises:
a lower housing having a hollow space therein;
the main shaft installed in the lower housing, the main shaft having a lower end protruding downwards from a lower end of the lower housing;
a second rotary cam fitted over the main shaft, the second rotary cam being rotated along with the main shaft;
a second movable cam interlocked with the second rotary cam so that the second movable cam linearly moves in the longitudinal direction; and
a lower spring provided on an upper surface of the second movable cam.

16. The hinge device as set forth in claim 3, wherein the lower operation unit comprises:
a lower housing having a hollow space therein;
the main shaft installed in the lower housing, the main shaft having a lower end protruding downwards from a lower end of the lower housing;
a second rotary cam fitted over the main shaft, the second rotary cam being rotated along with the main shaft;
a second movable cam interlocked with the second rotary cam so that the second movable cam linearly moves in the longitudinal direction; and
a lower spring provided on an upper surface of the second movable cam.

17. The hinge device as set forth in claim 4, wherein the lower operation unit comprises:
a lower housing having a hollow space therein;
the main shaft installed in the lower housing, the main shaft having a lower end protruding downwards from a lower end of the lower housing;
a second rotary cam fitted over the main shaft, the second rotary cam being rotated along with the main shaft;
a second movable cam interlocked with the second rotary cam so that the second movable cam linearly moves in the longitudinal direction; and
a lower spring provided on an upper surface of the second movable cam.

18. The hinge device as set forth in claim 5, wherein the lower operation unit comprises:
a lower housing having a hollow space therein;
the main shaft installed in the lower housing, the main shaft having a lower end protruding downwards from a lower end of the lower housing;
a second rotary cam fitted over the main shaft, the second rotary cam being rotated along with the main shaft;
a second movable cam interlocked with the second rotary cam so that the second movable cam linearly moves in the longitudinal direction; and
a lower spring provided on an upper surface of the second movable cam.

19. The hinge device as set forth in claim 6, wherein the lower operation unit comprises:
a lower housing having a hollow space therein;
the main shaft installed in the lower housing, the main shaft having a lower end protruding downwards from a lower end of the lower housing;
a second rotary cam fitted over the main shaft, the second rotary cam being rotated along with the main shaft;
a second movable cam interlocked with the second rotary cam so that the second movable cam linearly moves in the longitudinal direction; and
a lower spring provided on an upper surface of the second movable cam.

20. The hinge device as set forth in claim 7, wherein the lower operation unit comprises:
a lower housing having a hollow space therein;
the main shaft installed in the lower housing, the main shaft having a lower end protruding downwards from a lower end of the lower housing;
a second rotary cam fitted over the main shaft, the second rotary cam being rotated along with the main shaft;
a second movable cam interlocked with the second rotary cam so that the second movable cam linearly moves in the longitudinal direction; and
a lower spring provided on an upper surface of the second movable cam.
